(19) United States
(12) Patent Application Publication
(10) Pub. No.: US 2017/0304036 A1
(43) Pub. Date: Oct. 26, 2017

(54) TEETH WASHER STRUCTURE

(71) Applicant: Tai Fu Chen, Hsinchu City (TW)

(72) Inventor: Tai Fu Chen, Hsinchu City (TW)

(21) Appl. No.: 15/492,174

(22) Filed: Apr. 20, 2017

(30) Foreign Application Priority Data
Apr. 20, 2016 (TW) 105205572

(51) Int. Cl. A61C 17/02

(52) U.S. Cl. CPC A61C 17/0202; A61C 17/0214

(57) ABSTRACT

The present invention relates to a teeth washer structure, which includes: a guiding tube and an ejecting tube; the guiding tube includes a connection part, a tube body, an engage part and a first flow channel formed therein, a surface of the connection part is formed with a thread, and the portion of the first flow channel defined in the engage part is formed with a gradually-shrinking structure. One end of the ejecting tube is formed with a water inlet part connected to and communicated with the connection part in a watertight manner, another end thereof is disposed with an ejecting nozzle, the end of the ejecting tube where the ejecting nozzle is disposed is formed with a bendable structure, the interior of the ejecting tube is formed with a second flow channel mutually communicated with the first flow channel.

### BACKGROUND OF THE INVENTION

### 1. Field of the Invention

The present invention relates to a teeth washer structure, especially to a teeth washer structure in which a specially-design internal flow channel allows a strong water jet to be formed without being pressurized, and capable of being directly connected to a water tube of a shower head for providing a convenient operation.

### 2. Description of Related Art

People pay more attention to the health and beauty of teeth nowadays. More and more people visiting the dentist and using the teeth washer to prevent the damage from smoking or the other potentially harmful habit. Even the National Health Insurance in Taiwan pays for it.

However, the improvement of the teeth washer now is still focus on its shapes, materials, making it not easy to deform and reducing the cost. And the existing teeth washers are still have disadvantages: big volume, the need to operate with hydraulic pressure booster and not easy to move, and so on.

Based on the above, it became an important goal for dentists and other related industries to create a teeth washer with portability, convenience, and durability that is easy to produce, low-cost and can form powerful spouts without pressure booster.

### SUMMARY OF THE INVENTION

The present invention provides a teeth washer structure, which includes: a guiding tube and an ejecting tube; the guiding tube includes a connection part, a tube body, an engage part and a first flow channel formed therein, a surface of the connection part is formed with a thread, and the portion of the first flow channel defined in the engage part is formed with a gradually-shrinking structure. One end of the ejecting tube is formed with a water inlet part connected to and communicated with the connection part in a watertight manner, another end thereof is disposed with an ejecting nozzle, the end of the ejecting tube where the ejecting nozzle is disposed is formed with a bendable structure, the interior of the ejecting tube is formed with a second flow channel mutually communicated with the first flow channel. Accordingly, the teeth washer structure is provided with advantages of simple in production, low in cost, small in volume, light in weight, easy to be carried around and convenient in operation; moreover, a user can connect the teeth washer structure to a water tube of a conventional shower head at any desired time and location; furthermore, with the specially-designed flow channel formed in the teeth washer structure, the teeth washer structure is able to form a strong water jet without being additionally pressurized, so that the teeth washer structure of the present invention is more convenient in use and easy to be replaced when being applied in a daily life or a dental application.

The present invention provides a teeth washer structure, which includes: a guiding tube, including a tube body, a connection part formed at one side of the tube body and having a surface thereof formed with a thread, and an engage part formed at another side of the tube body, wherein the interior of the guiding tube is formed with a first flow channel, and the portion of the first flow channel defined in the engage part is formed with a gradually-shrinking structure; and an ejecting tube, including a water inlet part connected to the engage part, and an ejecting nozzle, wherein the interior of the ejecting tube is formed with a second flow channel, and the second flow channel is mutually communicated with the first flow channel.

Accordingly, the teeth washer structure is provided with advantages of simple in production, low in cost, small in volume, light in weight, easy to be carried around and convenient in operation; moreover, a user can connect the teeth washer structure to a water tube of a conventional shower head at any desired time and location, the teeth washer structure of the present invention is more convenient in use and easy to be replaced; furthermore, a pressurizing device is not required to be installed.

For allowing skilled people in the art to clearly understand the technical feature disclosed in the present invention and practice accordingly, the contents disposed in the specification, the claims and the drawings are provided to allow the skilled people in the art to easily understand the objectives and the advantages of the present invention, therefore details are illustrated with one embodiment for fully illustrating the characteristics and the advantages of the present invention.

### BRIEF DESCRIPTION OF THE DRAWINGS

FIG. 1 is a perspective view showing a teeth washer structure according to one embodiment of the present invention;

FIG. 2 is a schematic view showing the teeth washer structure in which a water flow being directly pressurized by a guiding tube according to one embodiment of the present invention;

FIG. 3 is a cross sectional view showing the teeth washer structure in which a flow channel allowing a water flow to pass according to one embodiment of the present invention;

FIG. 4A is a perspective view showing the teeth washer structure further including a water switch according to one embodiment of the present invention;

FIG. 4B is a cross sectional view showing the water switch and the teeth washer structure of FIG. 4A according to one embodiment of the present invention;

FIG. 5A is a perspective view showing the teeth washer structure in which the water switch being displaced to another location according to one embodiment of the present invention;

FIG. 5B is a cross sectional view showing the water switch and the teeth washer structure of FIG. 5A according to one embodiment of the present invention;

FIG. 6A is a perspective view showing the teeth washer structure in which the water switch being displaced to one another location according to one embodiment of the present invention; and

FIG. 6B is a cross sectional view showing the water switch and the teeth washer structure of FIG. 6A according to one embodiment of the present invention.

### DETAILED DESCRIPTION OF THE INVENTION

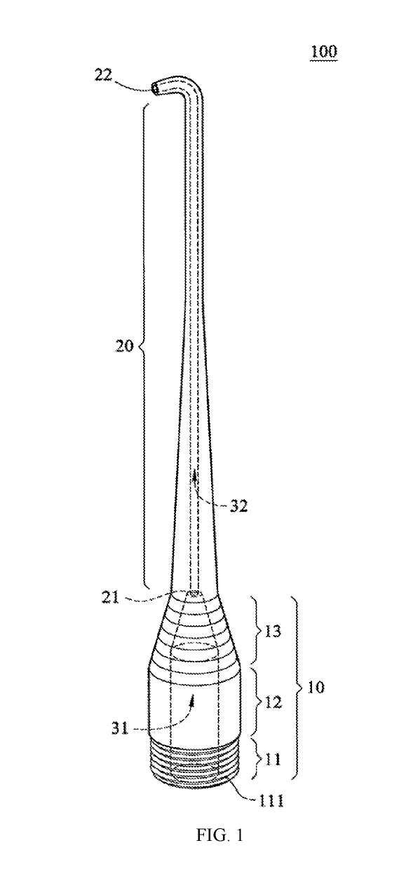

Referring to FIG. 1, according to one embodiment of the present invention, a teeth washer structure 100 including a guiding tube 10 and an ejecting tube 20 is provided, wherein the interior of the guiding tube 10 is formed with a first flow channel 31 allowing a water flow to pass, and the portion of the first flow channel 31 defined in an engage part 13 of the guiding tube 10 is formed with a gradually-shrinking structure with the diameter being gradually reduced towards the ejecting tube 20.

As shown in FIG. 1, the guiding tube 10 of the teeth washer structure 100 includes a connection part 11, a tube body 12 and the above-mentioned engage part 13. The connection part 11 is formed at one side of the tube body 12, a surface of the connection part 11 is formed with a thread 111, and the engage part 13 is formed at another side of the tube body 12.

As shown in FIG. 1, the interior of the guiding tube 10 is formed with the above-mentioned first flow channel 31, and the portion of the first flow channel 31 defined in the engage part 13 is formed with the above-mentioned gradually-shrinking structure. In addition, the appearance of the guiding tube 10 is formed as a hollow rectangular member or a columnar member.

The thread 111 formed on the surface of the connection part 11 can be a thread 111 with 0.5 inch in diameter, thereby being able to be directly connected to a water tube of a conventional shower head; accordingly, the teeth washer structure 100 of the present invention is able to be used in any place where the shower head is suitable to be installed.

The material of which the guiding tube 10 can be plastic, metal, alloy, silicon or a mixed material, what shall be addressed is that any material having properties of light in weight, strong in structure and not releasing any toxic substance can all be adopted. If a lower cost shall be considered, a polymer material which has already been commonly used in the prior art can also be adopted.

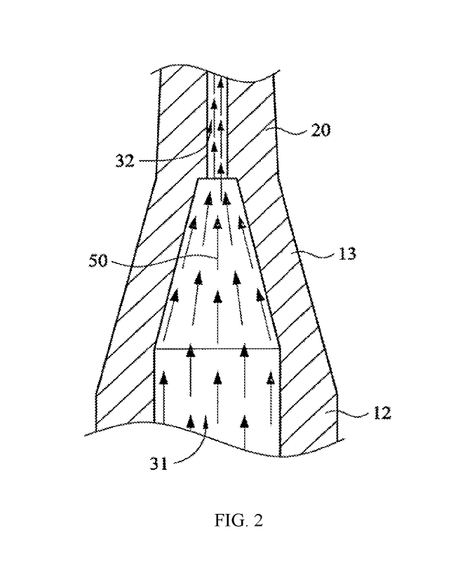

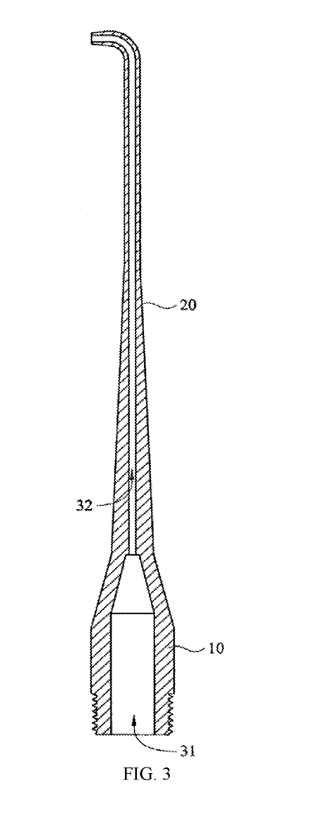

Referring from FIG. 1 to FIG. 3, the interior of the guiding tube 10 is formed in a hollow status, and the above-mentioned first flow channel 31 allowing a water flow to pass is formed therein. The portion of the first flow channel 31 defined in the engage part 13 is formed with the above-mentioned gradually-shrinking structure, for example a conical structure. In other words, the diameter of the first flow channel 31 having the gradually-shrinking structure is gradually reduced from the location where the tube body 12 engaged with the engage part 13 and along the engage part 13 and towards the ejecting tube 20.

As such, a water flow 50 passing the guiding tube 10 is able to be pressurized by the engage part 13 and the first flow channel 31 formed therein, so that a pressurizing device is not required to be additionally installed for the purpose of pressurization and for forming a strong water jet, thus the teeth washer structure of the present invention is more convenient in use and easy to be replaced when being applied in a daily life or a dental application.

As shown from FIG. 1 to FIG. 3, the ejecting tube 20 includes a water inlet part 21 and an ejecting nozzle 22. The water inlet part 12 is connected to and communicated with the engage part 13 in a watertight manner, and the ejecting nozzle 22 is disposed at another end. The above-mentioned end where the ejecting nozzle 22 is disposed on the ejecting tube 20 is formed with a bendable structure, so that teeth at different locations can be washed by utilizing a strong water jet. What shall be addressed is that the bendable angle range and the curvature of the bendable structure is not specified as long as the purpose of bending can be achieved.

The material of which the ejecting tube 20 can be plastic, metal, alloy, silicon or a mixed material, what shall be addressed is that any material having properties of light in weight, strong in structure and not releasing any toxic substance can all be adopted. If a lower cost shall be considered, a polymer material which has already been commonly used in the prior art can also be adopted.

The guiding tube 10 and the ejecting tube 20 of the teeth washer structure 100 provided by the present invention can be integrally formed. In addition, the guiding tube 10 and the ejecting tube 20 can be combined by utilizing a thread set, or the guiding tube 10 and the ejecting tube 20 can be combined with a buckle means, or the guiding tube 10 and the ejecting tube 20 can be combined by utilizing at least one screw.

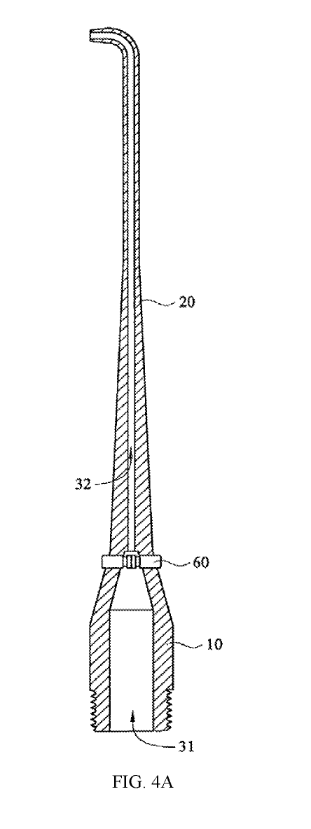

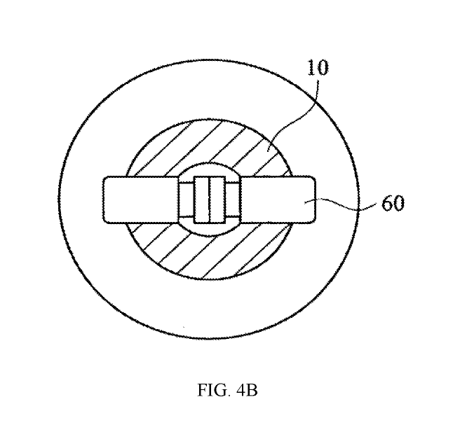

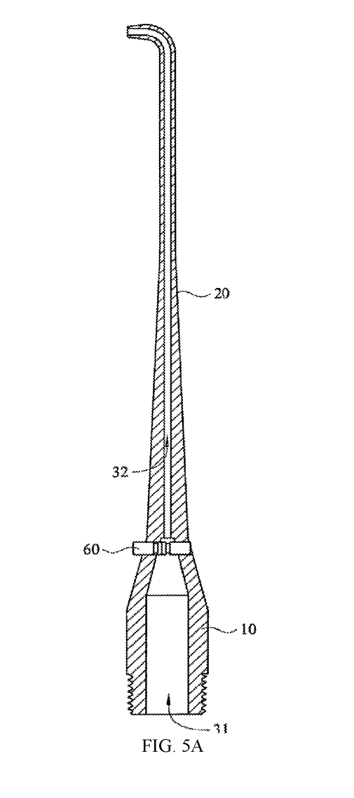

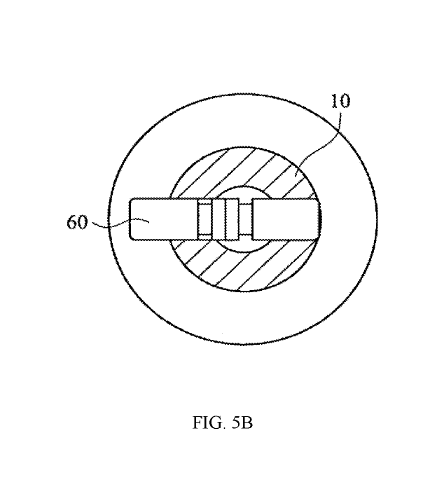

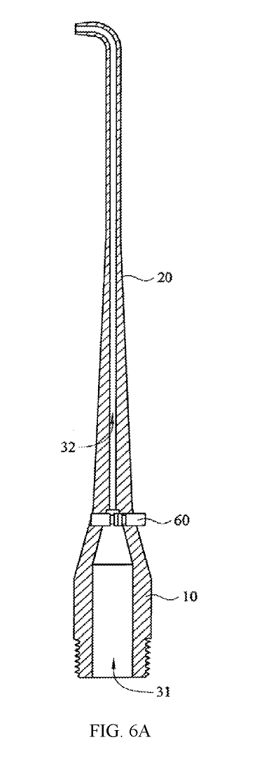

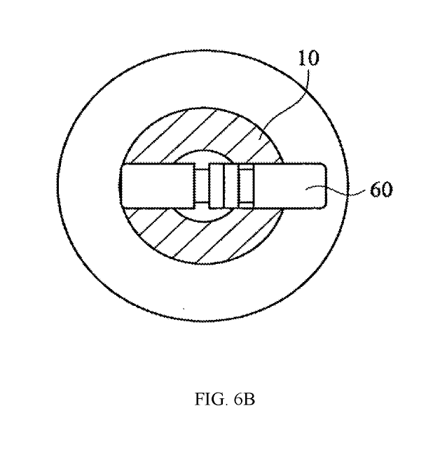

Referring from FIG. 4A to FIG. 6B, the teeth washer structure 100 further includes a water switch 60 for controlling the water amount passing the first flow channel 31 and a second flow channel 32 and ejected from the ejecting nozzle 22.

As shown from FIG. 4A to FIG. 6B, the water switch 60 can be controlled by a user for altering the diameter of the first flow channel 31 which allows the water flow to pass, and the water amount passing the first flow channel 31 and the second flow channel 32 and ejected from the ejecting nozzle 22 can be controlled. The water amount can be controlled from zero water amount with the first flow channel 31 being closed to a maximum water amount with the first flow channel 31 being fully opened.

Based on what has been disclosed above, no matter what material and formation means are adopted, the teeth washer structure 100 is provided with advantages of small in volume, light in weight, simple in production, low in cost, easy to be carried around and convenient in operation; moreover, the teeth washer structure 100 can be connected to the water tube of the conventional shower head at any desired time and location; furthermore, with the first flow channel 31 being formed as the gradually-shrinking structure and used for pressurizing the water flow, an additional pressurizing device is not required for forming a strong water jet, so that the teeth washer structure of the present invention is more convenient in use and easy to be replaced when being applied in a daily life or a dental application.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A teeth washer structure, including:
a guiding tube, including a tube body, a connection part formed at one side of the tube body and having a surface thereof formed with a thread, and an engage part formed at another side of the tube body, wherein the interior of the guiding tube is formed with a first flow channel, and the portion of the first flow channel defined in the engage part is formed with a gradually-shrinking structure; and
an ejecting tube, including a water inlet part connected to the engage part, and an ejecting nozzle, wherein the interior of the ejecting tube is formed with a second flow channel, and the second flow channel is mutually communicated with the first flow channel.

2. The teeth washer structure as claimed in claim 1, wherein the thread is formed as a thread with 0.5 inch in diameter, and directly connected to a water tube of a shower head.

3. The teeth washer structure as claimed in claim 1, wherein the end where the ejecting nozzle is disposed on the ejecting tube is formed with a bendable structure.

4. The teeth washer structure as claimed in claim 1, wherein the guiding tube is made of a material having properties of light in weight, strong in structure and not releasing any toxic substance.

5. The teeth washer structure as claimed in claim 1, wherein the ejecting tube is made of a material having properties of light in weight, strong in structure and not releasing any toxic substance.

6. The teeth washer structure as claimed in claim 1, wherein the guiding tube and the ejecting tube are integrally formed.

7. The teeth washer structure as claimed in claim 1, wherein the guiding tube and the ejecting tube are combined by utilizing a thread set.

8. The teeth washer structure as claimed in claim 1, wherein the guiding tube and the ejecting tube are combined with a buckle means.

9. The teeth washer structure as claimed in claim 1, wherein the guiding tube and the ejecting tube are combined by utilizing at least one screw.

10. The teeth washer structure as claimed in claim 1, wherein the guiding tube is formed as a rectangular member or a columnar member.

11. The teeth washer structure as claimed in claim 1, further including a water switch.
